(19) United States
(12) Patent Application Publication
(10) Pub. No.: US 2013/0263181 A1
(43) Pub. Date: Oct. 3, 2013

(54) SYSTEMS AND METHODS FOR DEFINING VIDEO ADVERTISING CHANNELS

(71) Applicant: SET MEDIA, INC., San Francisco, CA (US)

(72) Inventors: Robert Philip IMPOLLONIA, San Mateo, CA (US); Jonathan Robert DODSON, San Francisco, CA (US); Michael Gregory SULLIVAN, San Francisco, CA (US); Ali ZANDIFAR, San Francisco, CA (US); Matthew TILLMAN, San Francisco, CA (US)

(73) Assignee: SET MEDIA, INC., San Francisco, CA (US)

(21) Appl. No.: 13/793,384

(22) Filed: Mar. 11, 2013

Related U.S. Application Data
(60) Provisional application No. 61/618,410, filed on Mar. 30, 2012.
(60) Provisional application No. 61/660,450, filed on Jun. 15, 2012.

(51) Int. Cl. H04N 21/81

(52) U.S. Cl. CPC H04N 21/812
USPC 725/32

(57) ABSTRACT

Described are computer-based methods and apparatuses, including computer program products, for defining video advertising channels. A set of requirements is received for an advertising channel. A training set of video content is identified based on the set of requirements. A set of baseline categorizations is received that includes, for each video in the training set of video content, a categorization for each requirement from the set of requirements. A set of experiments is calculated based on the training set of video content and the set of baseline categorizations to determine video content for the advertising channel.

### RELATED APPLICATIONS

The present application relates to and claims priority under 35 U.S.C. 119(e) to U.S. Provisional Application Nos. 61/618,410, filed on Mar. 30, 2012 and entitled “Automatic Model Training System,” and 61/660,450, filed on Jun. 15, 2012 and entitled “Automatic Model Training System,” the disclosures of which are hereby incorporated by reference herein in their entirety.

### TECHNICAL FIELD

The technical field relates generally to computer-based methods and apparatus, including computer program products, for defining video advertising channels, and more particularly to computer-based methods and apparatus for automatically generating classification models to define the video advertising channels.

### BACKGROUND

To reach out to online consumers, companies often develop online marketing campaigns that combine advertisements with online content, such as text and/or static images. Advertisements can be selected in a number of different ways. At a basic level, advertisements can be randomly selected and deployed. However, there is no guarantee that the selected advertisements are pertinent to a particular user. Targeted advertisements, on the other hand, are customized based on information available for the user, such as the content of the website the user is browsing, and/or metadata associated with the website content (and/or static images). The metadata information can include, for example, a user's cookie information, a user's profile information, a user's registration information, the online content previously viewed by the user, and the types of advertisements previously responded to by the user. As another example, targeted advertisements can be selected based on information about the online content desired to be viewed by the user. This information can include, for example, the websites hosting the content, the selected search terms, and metadata about the content provided by the website. In a further example, advertisements can be combined with online content using a combination of these approaches.

It is often beneficial to develop models that classify media into various categories, such that advertisements can be matched with particular categories of media. For example, if an advertiser wishes to reach consumers that view sports, the advertiser can select a “sports” category for its advertisements (e.g., which may include sports-related websites, as well as sports apparel websites, and/or the like). However, while many tools have been developed to classify textual content and static images, little progress has been made for digital video. Many currently available methods utilize existing text-based or metadata-based methods to classify videos (or to assign labels to videos), but do not take into account the actual content of the video itself. For example, the metadata may include general information about the video including the category (e.g., entertainment, news, sports) or channel (e.g., ESPN, Comedy Central) associated with the video. However, the metadata may not include more specific information about the video, such as information about the visual and/or audio content of the video.

Classifying online video can be further complicated by the fact that such classification often involves processing orders of magnitude more data than the amount required to classify online text or images. Additionally, videos contain multiple facets of information, and the combination of sight, sound and/or motion can have an inherently subjective impact on the viewer. As such, classifications of video content can be inherently more subjective than other forms of media. Further, for classification methods to be marketed and used for advertising campaigns, there often needs to be some type of best-practice review to ensure the classification methods continue to perform at an acceptable level. While it is difficult to design a perfect classification system, it is desirable for the system's vendor to demonstrate how a classification was made, and to show that there was no better way to go about classifying that particular video given the tradeoffs of configuring the classification system to make a different decision.

### SUMMARY OF THE INVENTION

The computerized methods and apparatus disclosed herein provide for “soft” classifications (e.g., where such classifications are at least partially subjective in nature) of online videos for advertising channels that are designed to meet the unique needs of specific television/internet advertisers.

A brief summary of various exemplary embodiments is presented. Some simplifications and omissions may be made in the following summary, which is intended to highlight and introduce some aspects of the various exemplary embodiments, but not limit the scope of the invention. Detailed descriptions of a preferred exemplary embodiment adequate to allow those of ordinary skill in the art to make and use the inventive concepts will follow in the later sections.

In one aspect, there is a computerized method for defining an advertising channel. The method includes receiving, by a computing device, a set of requirements for an advertising channel. The method includes identifying, by the computing device, a training set of video content based on the set of requirements. The method includes receiving, by the computing device, a set of baseline categorizations comprising, for each video in the training set of video content, a categorization for each requirement from the set of requirements. The method includes calculating, by the computing device, a set of experiments based on the training set of video content and the set of baseline categorizations to determine video content for the advertising channel.

In another aspect, a system for defining an advertising channel is featured. The system includes a database. The system includes a server in communication with the database. The server is configured to receive a set of requirements for an advertising channel and store the set of requirements in the database. The server is configured to identify a training set of video content based on the set of requirements and store the training set of video content in the database. The server is configured to receive, for each video in the training set of video content, a set of baseline categorizations for each requirement from the set of requirements. The server is configured to calculate a set of experiments based on the training set of video content and the set of baseline categorizations to determine video content for the advertising channel.

In another aspect, a computer program product is featured. The computer program product is tangibly embodied in a non-transitory computer readable medium. The computer program product includes instructions being configured to cause a data processing apparatus to receive a set of requirements for an advertising channel. The computer program product includes instructions being configured to cause a data processing apparatus to identify a training set of video content based on the set of requirements. The computer program product includes instructions being configured to cause a data processing apparatus to receive a set of baseline categorizations comprising, for each video in the training set of video content, a categorization for each requirement from the set of requirements. The computer program product includes instructions being configured to cause a data processing apparatus to calculate a set of experiments based on the training set of video content and the set of baseline categorizations to determine video content for the advertising channel.

The techniques, which include both methods and apparatuses, described herein can provide one or more of the following advantages. Advertisers can define an advertising channel using soft advertising requirements, and automatically train a classification model to identify video content for the advertising channel. Due to the large amount of data available for video content, the classification model training can employ cloud and/or cluster-based computing methods to scale the training techniques. Further, the classification model can be adapted to mimic more subjective forms of classification.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other aspects, features, and advantages of the present invention, as well as the invention itself, will be more fully understood from the following description of various embodiments, when read together with the accompanying drawings.

FIG. 1A is a diagram of an exemplary system for defining video advertising channels;

FIG. 1B is a diagram of the channel generator from FIG. 1A, for defining video advertising channels;

FIG. 1C is a diagram of the panel judgment components from FIG. 1B for defining video advertising channels;

FIG. 1D is a diagram of the training components from FIG. 1B for defining video advertising channels;

FIG. 1E is a diagram of the automated judgment components from FIG. 1B for defining video advertising channels;

FIG. 1F is a diagram of the probabilistic reasoning inference engine components from FIG. 1B for defining video advertising channels;

FIG. 2 is an exemplary set of requirements for defining video advertising channels;

FIG. 3 is an exemplary diagram of a computerized method for defining video advertising channels;

FIG. 4 is an exemplary diagram of a computerized method for tracking the performance of a classification model to define a video advertising channel;

FIG. 5 is an exemplary diagram illustrating the calculation of a classification model for defining an advertising channel; and

FIG. 6 is an exemplary table showing various information sources, and the associated information types for each information source.

### DETAILED DESCRIPTION

In general, computerized systems and methods provide machine learning techniques that can be used to develop a customized online advertising channel based on individual subjective (or “soft”) requirements defined by each advertiser. The advertiser defines a set of requirements for the advertising channel that are used to differentiate between what video content should, and should not, be included in the advertising channel. The system uses the requirements in conjunction with a training set of video content to develop a classification model that can automatically analyze new video content and determine whether the video content should be added to the advertising channel (or not).

The requirements for the custom advertising channel can be defined as a set of questions and acceptable answers (e.g., as if obtained from a panel of human viewers). The video content itself can be obtained from television resources, on-demand resources, and/or from the internet. The classification model can automatically assign applicable media files to proper advertising channels. Further, the techniques provide for analysis of how and why a classification was made (e.g., why a video was or was not classified into a particular video channel), and mechanisms for human review and quality assurance of the techniques to ensure, for example, that the classification models continue to perform properly, and are updated to take into account new data and information. The techniques can utilize cloud data storage and processing to generate and train a master set of experiments, from which a classification model is determined for the particular advertising channel.

A ground-truth data set can provide baseline classification data for the training set of video content. The ground-truth data set can be obtained automatically (e.g., by running existing classification models on the training set), or by soliciting a live panel review to determine whether the training videos should be included and/or excluded for an advertising channel based on the channel requirements (e.g., to define a training set of data for generating a classification model that mimics the panel's perception of the content). The ground-truth data is used to generate statistical models that can automatically satisfy the advertiser's requirements (e.g., re-create answers to an advertiser's defined questions), and therefore properly categorize a video into a particular advertising channel. Once classification models are generated, the techniques can continue to ingest new video and update the existing classification models based on human-panel data, automatic model improvement using machine learning, and/or the like.

For ease of description, the following “use case” is used to help explain various aspects of the techniques disclosed herein. Company “Brand X,” a large soda company, spends millions of dollars per year in sponsorships and advertising to promote the “Show X” television program. Brand X's chief marketing officer (“CMO”) learns that the audience for “Show X” spends a lot of time watching “Show X” digital videos while surfing the internet (e.g., in fact much more time than they spend watching the television program “Show X” itself). Brand X therefore wants to make sure that their existing advertising campaigns are being shown against the online “Show X” content so that, for example, Brand X can take advantage of the audience's attention while they are watching the “Show X” content online in order to promote its brand (especially since users may spend more time online rather than watching the “Show X” television show itself). As another example, Brand X may want to stop a competitive brand from advertising in conjunction with the online “Show X” content, which could detrimentally work against the Brand X message they are promoting in their existing Television advertising campaign.

However, traditional advertising methods often fall short of satisfying Brand X's advertising goals because, for example, Brand X has no way of knowing what content their ads will run against when buying advertising slots for online digital video. This is because existing online advertising solutions can not provide the fine-level of classification required to identify content related to “Show X.” As another example, if Brand X's ads runs against the wrong content, their advertising objectives could be compromised, such as by running against objectionable content and/or poor-quality content (e.g., which could potentially damage the company's brand).

The techniques described herein can be used to achieve Brand X's advertising goals (and avoid related advertising problems, such as advertising in conjunction with offensive content) by automatically learning the soft classification(s) required to define Brand X's custom advertising channel with panel-generated ground truth data. Although the specification and/or figures generally describe the techniques in terms of the Brand X use case, the Brand X use case is intended to be illustrative only, as these techniques can work equally well to generate other types of advertising channels.

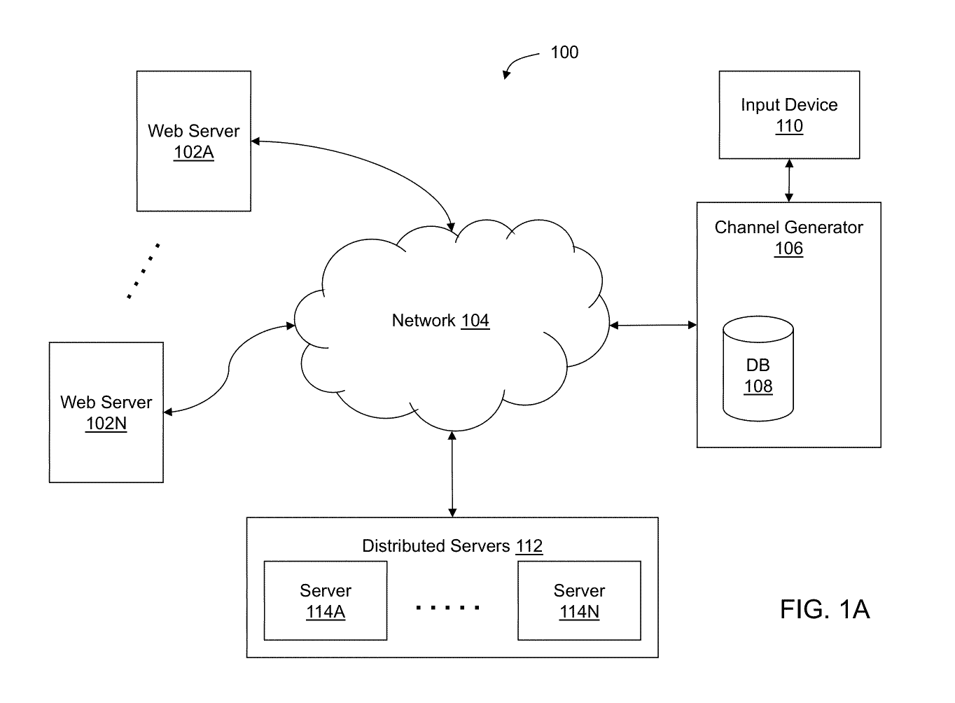

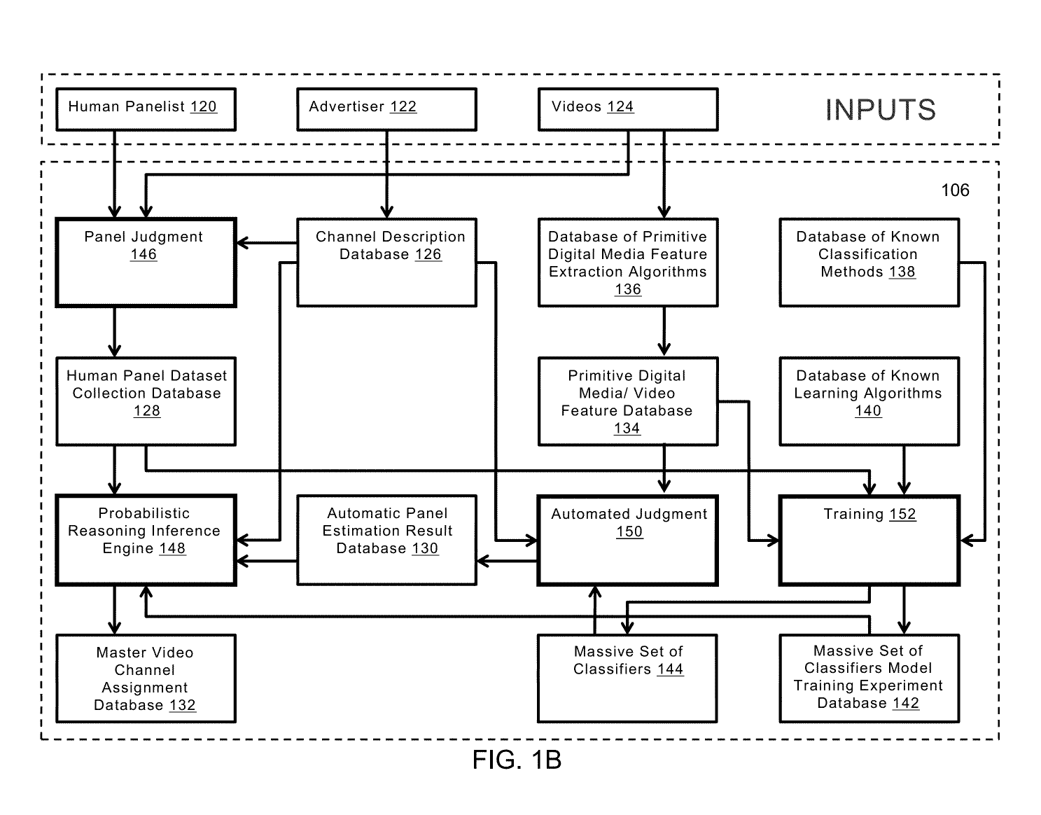

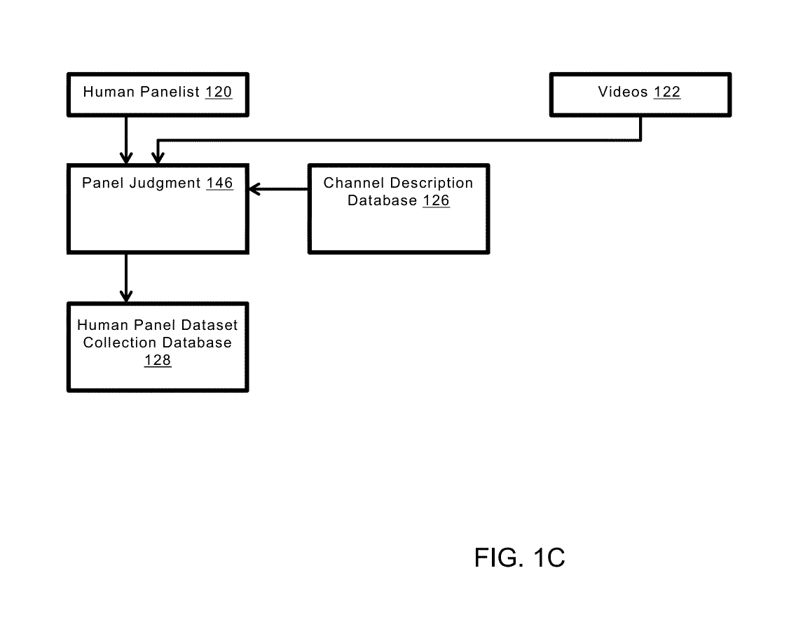

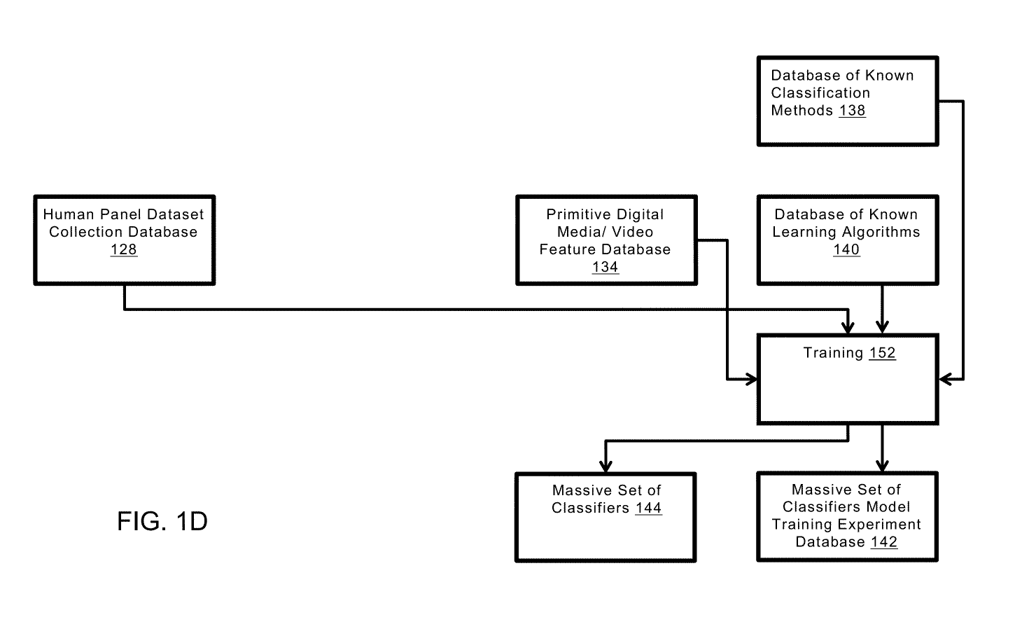

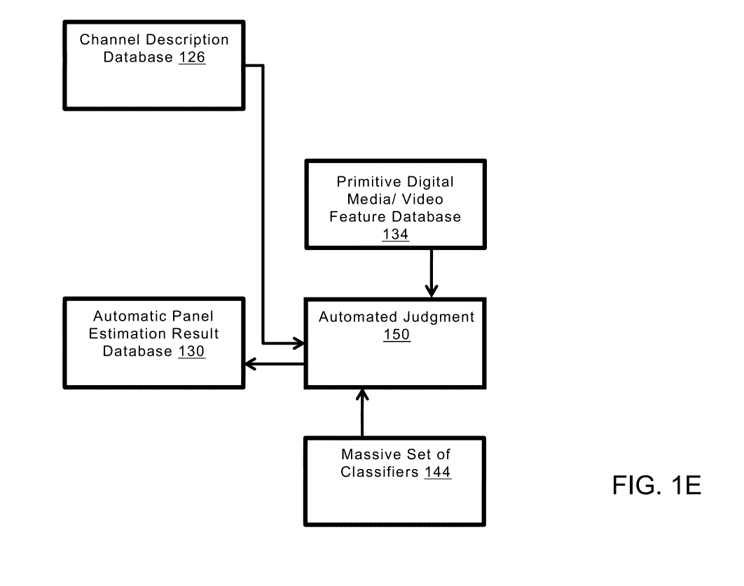

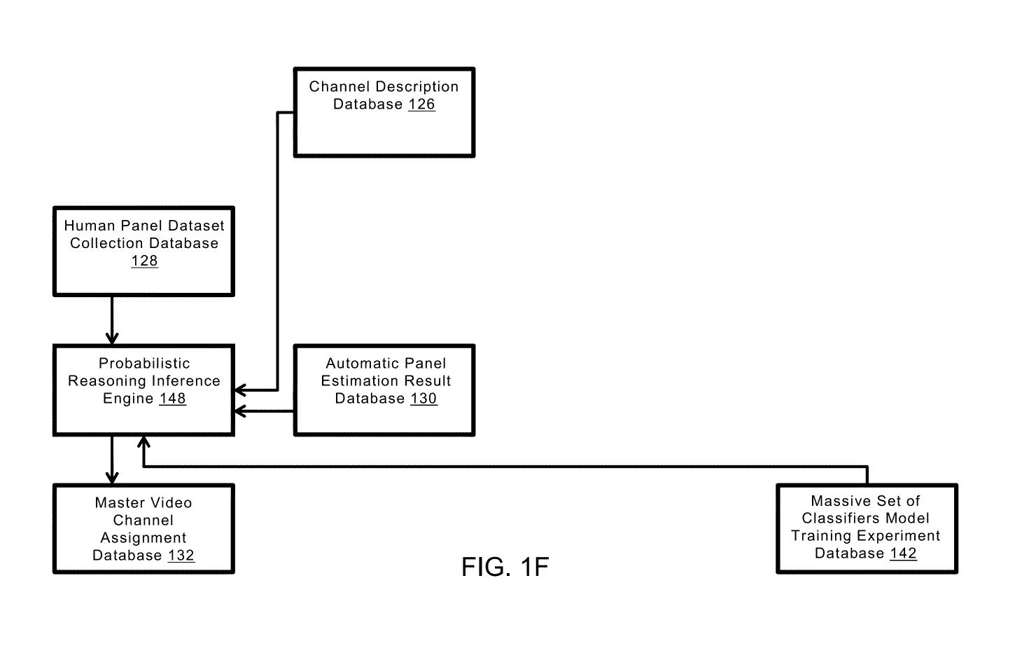

FIG. 1A is a diagram of an exemplary system 100 for defining video advertising channels. System 100 includes web servers 102A through 102N (collectively, web servers 102). Web servers 102 are in communication with network 104 (e.g., the internet). Channel generator 106, which includes database 108, is in communication with network 104. Input device 110 is in communication with channel generator 106. A group of distributed servers 112, including servers 114A through 114N, are in communication with network 104.

Web servers 102 are configured to serve web content to internet users (e.g., via network 104). For example, web servers 102 serve web pages, audio files, video files, and/or the like to a web browser (e.g., being executed on a computer connected to the internet, not shown) if the web browser is pointed to a URL served by the web servers 102. Channel generator 106 is configured to execute the techniques described herein to train and generate a classification model that defines what content will (or will not) be associated with a particular advertising channel. The channel generator 106 stores related information in database 108 (e.g., a relational database management system), as described herein. Input device 110 can be, for example, a personal computer (PC), laptop, smart phone, and/or any other type of device capable of inputting data to the channel generator 106. The distributed servers 112 can be, for example, cloud-based storage and/or computing, and can be used by the channel generator 106 to distribute the processing required to generate a classification model for a content channel.

The channel generator 106 can be a distributed, scalable, cluster computing “big data” platform. The channel generator 106 can include processing and storage resources that can be allocated dynamically, as needed by the channel generator 106. Such a configuration can allow large numbers of training experiments to be conducted simultaneously on a large set of processors, when needed, without the need to purchase and maintain massive amounts of dedicated hardware. The channel generator 106 can be configured to generate reports regarding the classification of a video (e.g., which explains how the classification was reached, explains how the classification is in line with best practices for the organization of video content, etc.).

The computing devices in FIG. 1A can include various hardware components, including processors and memory. The system 100 is an example of a computerized system that is specially configured to perform the computerized methods described herein. However, the system structure and content recited with regard to FIG. 1A are for exemplary purposes only and are not intended to limit other examples to the specific structure shown in FIG. 1A. As will be apparent to one of ordinary skill in the art, many variant system structures can be architected without departing from the computerized systems and methods described herein.

In addition, information may flow between the elements, components and subsystems described herein using any technique. Such techniques include, for example, passing the information over the networks (e.g., network 104) using standard protocols, such as TCP/IP, passing the information between modules in memory and passing the information by writing to a file, database, or some other non-volatile storage device. In addition, pointers or other references to information may be transmitted and received in place of, or in addition to, copies of the information. Conversely, the information may be exchanged in place of, or in addition to, pointers or other references to the information. Other techniques and protocols for communicating information may be used without departing from the scope of the invention.

FIG. 1B is a diagram of the channel generator 106 from FIG. 1A, for defining video advertising channels. The inputs into the channel generator 106 include human panelist data 120, advertiser data 122, and video data 124 (e.g., from input device 110). The channel generator 106, as shown in the exemplary embodiment, includes a number of databases, including the channel description database 126, the human panel dataset collection database 128, the automatic panel estimation result database 130, the master video channel assignment database 132, the primitive digital media/video feature database 134, the database of primitive digital media feature extraction algorithms 136, the database of known classification methods 138, the database of known machine learning algorithms 140, the massive set of classifiers model training experiment database 142, and the massive set of classifiers 144. While FIG. 1B shows these databases as separate databases, one of skill in the art can appreciate that the databases can be stored as a single database, two databases, and/or any number of databases residing on any combination of the same or different computing devices. The channel generator 106 also includes a panel judgment module 146, probabilistic reasoning inference engine 148, automated judgment module 150, and training module 152.

The components shown in FIG. 1B are described in further detail below with reference to FIGS. 1C-1F. As a general introduction, according to some embodiments the panel judgment unit 146 manages the process of conducting surveys with human panelists to complete channel description surveys (e.g., subjective questions defined by an advertiser) for a sample set of videos. Such surveys provide ground-truth data, which the system uses to automatically train classifiers for the advertising channel. The automated judgment module 150 uses a set of computerized classifiers to calculate whether videos from the training set of videos satisfy the channel descriptions (e.g., by calculating estimated answers to channel description questions). The training module 152 calculates new classifiers that determine membership of the example videos based on the panel judgment data. The probabilistic reasoning inference engine 148 generates the ultimate classifier combinations from the resulting master set of classifiers, which are used to define a video channel for a particular advertiser.

FIG. 1C is a diagram of the panel judgment components from FIG. 1B for defining video advertising channels. FIG. 1C includes the human panelist data 120, video data 122, the channel description database 126, which are all in communication with the panel judgment module 146. The panel judgment module 146 is also in communication with the human panel dataset collection database 128.

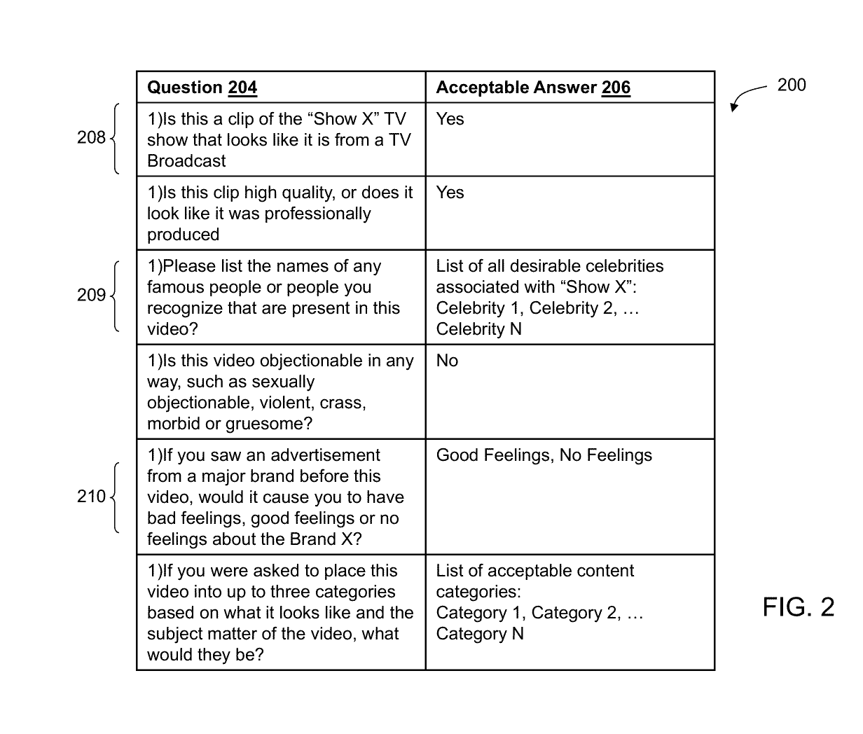

The channel generator 106 uses the channel description database 126 to store the channels that are created by (or for) advertisers. Each channel consists of a set of questions and corresponding acceptable answers regarding video content that could be asked to a panel of people, which is described in further detail with FIG. 2. Referring to the human panelist data 120, the panel judgment unit 146 receives a human panel's subjective answers to questions from the channel description database 126 for the set of videos 122. The panel judgment unit 146 can be configured to manage the process of conducting surveys with the human panelists 120 based on the videos 122. The panel judgment unit 146 can be configured to track the performance of individual panel members. The panel judgment unit 146 can provide an interface for viewing the collected data.

The channel generator 106 stores the panel answers in the human panel dataset collection database 128. In some embodiments, a table in the database stores information about the panel members (e.g., educational background, age, etc.). In some embodiments, a table in the database stores information about the videos (e.g., the videos 122). In some embodiments, a table in the database stores a set of questions answered by the panel members. In some embodiments, a table in the database provides stores the answer that a given panel member provided for a given question for a given video. This table can be “sparse,” in that not all panel members will have answered all questions for all videos in the system.

FIG. 1D is a diagram of the training components from FIG. 1B for defining video advertising channels. The human panel dataset collection database 128, the primitive digital media/video feature database 134, the database of known classification methods 138, and the database of known learning algorithms 140 are inputs to the training module 152. The training module 152 is also in communication with the massive set of classifiers model training experiment database 142 and the massive set of classifiers 144.

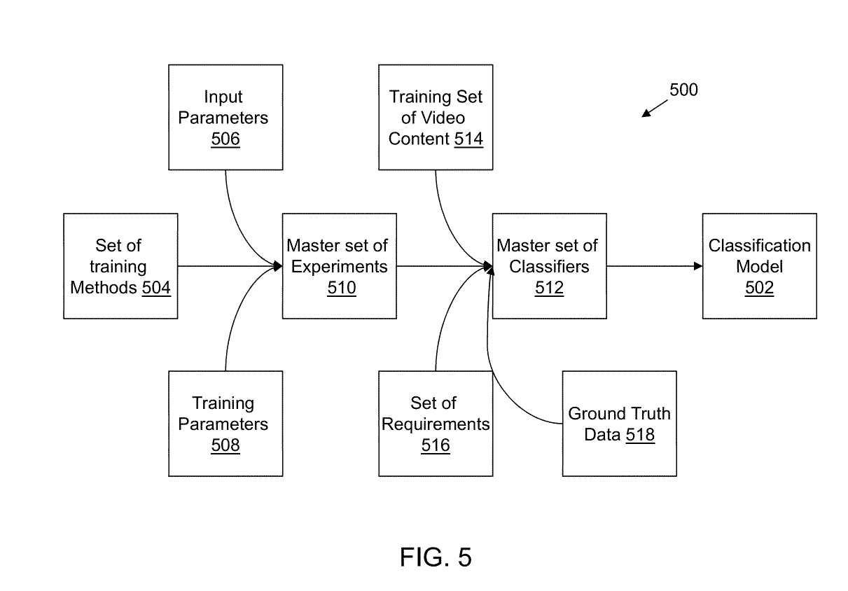

The training module 152 adds new classifiers to the massive set of classifiers 144 that provide estimated answers to questions from the channel description database 126 based on example videos 124 and panel judgment data 120, which are stored in the human panel dataset collection database 128. The master set of classifiers is described further with respect to FIG. 5. The channel generator 106 uses the primitive digital media/video feature database 134 to store the values of metrics regarding the metadata, image and audio content of the various videos 124. For example, the primitive digital media/video feature database 134 can store the percentage of pixels in each color histogram bucket for various frames of a video, or the words in text comments associated with a video.

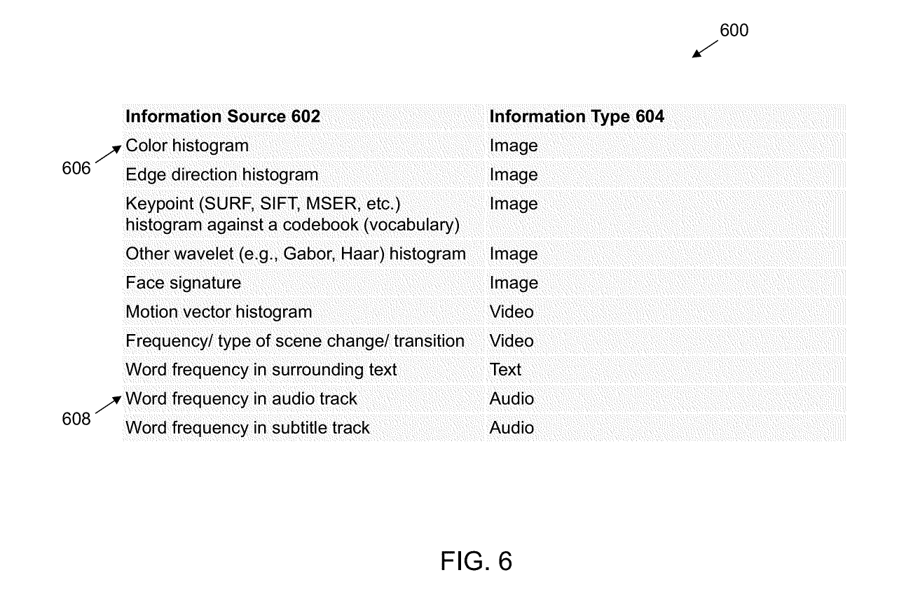

The channel generator 106 can calculate the features using the algorithms stored in the database of primitive digital media feature extraction algorithms 136. The channel generator 106 uses the database 136 to store a number of different algorithms for extracting features, such as low-level features, from media files and associated web pages (e.g., videos 124). For example, one algorithm can be configured to extract edge histograms from the frames of a video. Each feature extraction algorithm can be implemented as, for example, an executable program that runs on Linux or a Java class file. Each algorithm may output a different amount or format of data to represent the features that it extracts. The extracted features are stored in the primitive digital media/video feature database 134, and serve as the input to various machine learning and classification algorithms executed by the training module 152. Feature extraction, and other data preprocessing, is described further with respect to FIG. 6. Further, U.S. patent application Ser. No. 12/757,276, filed on Apr. 9, 2010 and entitled “Systems and Methods for Matching an Advertisement to a Video,” describes video preprocessing, which is hereby incorporated by reference herein in its entirety.

The channel generator 106 stores a collection of classification algorithms in the database of known classification methods 138. These can be executable programs, like the feature extraction algorithms. As input, each classification algorithm can take the features of a video as extracted by some subset of the feature extraction algorithms and stored in the primitive digital media/video feature database 134. As output, each algorithm can provide a classification for the video (e.g., an estimated answer to some question that comprises a channel, as defined in the channel description database 126), which the training module 152 stores in the automatic panel estimation result database 130. The input parameters and training parameters for the classification methods (or training algorithms) are described further with respect to FIG. 5.

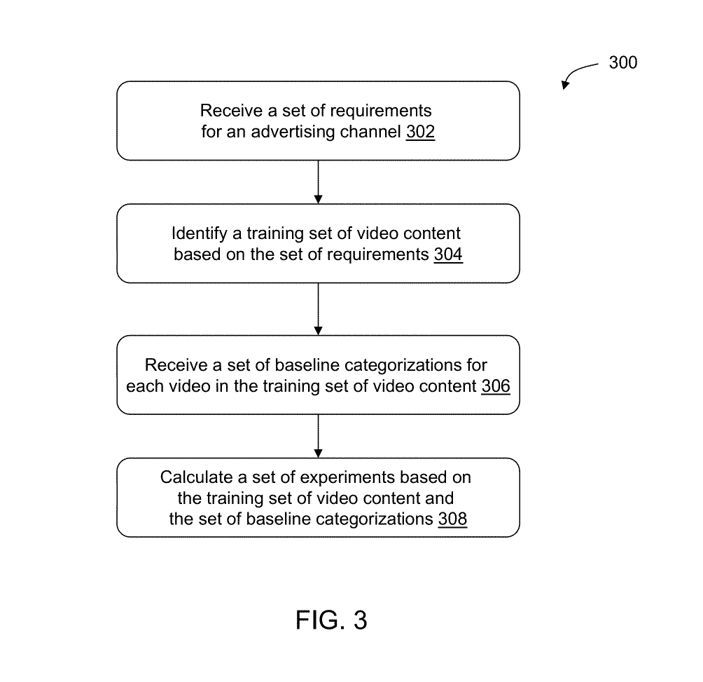

The channel generator 106 stores a collection of algorithms in the database of known machine learning algorithms 140 that build automated classifiers to answer questions about videos, executed by the training module 152. Each trained classifier is of a type from the database of known classification methods 138. A trained classifier is trained to answer a specific question (e.g., question 208 from FIG. 2) based on example videos and/or associated data. For example, a trained classifier can use features extracted from the videos 124, as stored by the primitive digital media/video feature database 134, and classifications for the videos from the human panel dataset collection database 128. The training module 152 can be configured to initiate the training of new classifiers. The training module 152 can be configured to generate user interfaces for viewing the results of previous experiments (e.g., the system can generate charts and graphs to visualize trends in experimental results). The training process is described further with respect to FIG. 3.

The training module 152 can execute the trained classifier(s) for ultimate deployment of the trained classifier(s) to classify novel videos, not yet classified, for the question of interest based on a model learned from the training data. The channel generator 106 uses the massive set of classifiers model training experiment database 142 to record experiments conducted by the training module 152. An experiment consists of, for example, using an algorithm from the database of known machine learning algorithms 140 to train a classifier of a type from the database of known classification methods 138 using training data consisting of video features from the primitive digital media/video feature database 134 and known information about those videos from the human panel dataset collection database 128.

For example, for an experiment, the database 142 records which training algorithm and classification method the training module 152 used, what input data the training module 152 used, what values were used for each of the various configuration settings that the training and classification methods may offer, and the accuracy of the classifier as measured against its test dataset and by ongoing quality assurance (QA). Analysis of the data in database 142 can help determine what classifiers and settings tend to yield the best results, and in which circumstances.

The channel generator 106 uses the massive set of classifiers 144 to store the classifiers that the training module 154 trained using the algorithms in the database of known machine learning algorithms 140. Some of the classifiers may be marked as “production” classifiers, which means that experimental and QA results indicate they perform well enough to contribute to the master video channel assignment database 132, described further below.

FIG. 1E is a diagram of the automated judgment components from FIG. 1B for defining video advertising channels. The channel description database 126, the primitive digital media/video feature database 134, and the massive set of classifiers 142 are inputs to the automated judgment module 150. The automated judgment module 150 is in communication with the automatic panel estimation result database 130.

The automated judgment module 150 uses classifiers from the massive set of classifiers database 144 to provide estimated answers to questions from the channel description database 126 for a set of videos (e.g., videos 124), represented as extracted primitive features from database 134. The channel generator 106 uses the automatic panel estimation result database 130 to store the answers to questions about videos as predicted by automated classifiers. This database can have, for example, the same form as the human panel dataset collection database 128, except that in the place of human panel members it stores classification models trained via a variety of machine learning algorithms.

FIG. 1F is a diagram of the probabilistic reasoning inference engine components from FIG. 1B for defining video advertising channels. The channel description database 126, the human panel dataset collection database 128, the automatic panel estimation result database 130, and the massive set of classifiers model training experiment database 142 are inputs to the probabilistic reasoning inference engine 148. The probabilistic reasoning inference engine 148 is in communication with the master video channel assignment database 132.

The probabilistic reasoning inference engine 148 combines judgments from classifiers in the massive set, stored in the automatic panel estimation result database 130, for individual questions from the channel description database 126 to determine final channel assignment(s) for a video. The probabilistic reasoning inference engine 148 stores the assignments in the master video channel assignment database 132. These assignments determine which channels a video is considered to match for the purpose of selecting ads to accompany it. The channel generator 106 can be configured to facilitate viewing and managing the channels defined in the master video channel assignment database 132 (e.g., including the criteria associated with a channel, the videos assigned to the channel, etc.). The channel generator 106 can further be configured to predict and/or monitor the estimated future viewership and content for each channel. The classification model is described further with respect to FIG. 5.

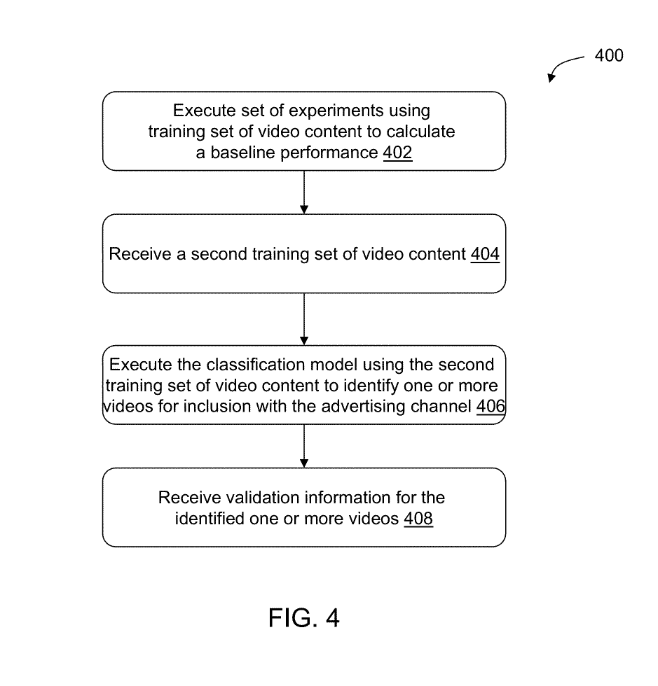

The channel generator 106 can be configured to manage the QA process for the system. For example, the channel generator 106 can determine/adjust a portion of automated decisions (e.g., calculated by the probabilistic reasoning inference engine) that should be checked/confirmed via a panel. The channel generator 106 can generate charts, graphs, etc. to visualize trends in the data. For example, the channel generator 106 can help determine when QA results show that a classifier is performing poorly enough so that it should be removed from production (e.g., removed from actual deployment to categorize videos into an advertising channel). The validation process is described further with respect to FIG. 4.

In some examples, rather than directly providing rules to define an advertising channel, an advertiser can provide exemplary videos that fit, and don't fit, their desired channel. The probabilistic reasoning inference engine 148, a higher-level machine learning system, can construct probabilistic rules to define membership in the channel based upon classification results from the lower-level classifiers that answer individual questions. The rules are stored in the channel description database 126 as if they had been directly provided by the advertiser 122, and may be subject to QA and retraining over time like the lower-level classifiers, as described herein. When making decisions, the probabilistic reasoning inference engine 148 may also consider the historical accuracy of these and similar classifiers, based on records from the QA process and the training experiment database 142.

FIG. 2 illustrates an exemplary set of requirements 200 for defining video advertising channels. The set of requirements 200 includes a table of questions 204 and answers 206 that define the requirements an advertising company (e.g., Brand X) would like to use to define its advertising channel. For example, referring to requirement 208, a video should only be included in the advertising channel if it is a clip of “Show X” and the clip looks like it is from a television broadcast (e.g., it is a copy of a portion of the “Show X” broadcast). As another example, requirement 209 provides an acceptable list of celebrities in the video content (e.g., Celebrity 1 through Celebrity N). As another example, requirement 210 provides subjective answers. Videos associated with the advertising channel can only evoke “good feelings” or “no feelings” from a viewer.

The techniques described herein can be used to determine membership for digital media files in one or more advertising channels (e.g., by tagging the files with labels, grouping the files, etc.), where the advertising channels are defined based on the subjective requirements set forth by the advertiser (e.g., Brand X). FIG. 3 is an exemplary diagram of a computerized method 300 for defining video advertising channels. Referring to FIG. 1A, at step 302 the channel generator 106 receives a set of requirements for an advertising channel (e.g., a question/answer set provided by Brand X, as shown in FIG. 2). At step 304, the channel generator 106 identifies a training set of video content based on the set of requirements (e.g., collected from web servers 102). At step 306, the channel generator 106 receives a set of baseline categorizations for each video in the training set of video content (e.g., from a set of panel analysts). At step 308, the channel generator 106 calculates a set of experiments based on the training set of video content and the set of baseline categorizations to determine video content for the advertising channel.

Referring to step 302, the channel generator 106 receives requirements from the advertiser that define the advertising channel. The requirements can be collected, for example, in person by a salesperson or account manager. The requirements can be converted into a series of questions and acceptable answers (e.g., as if the requirements are posed to a panel of people). Referring to FIG. 2, for example, the set of requirements 200 can be collected from Brand X, and electronically input into the channel generator 106. For example, the input device 110 can transmit the set of requirements 200 to the channel generator 106 by transmitting one or more data files to the channel generator 106, by updating records in database 108, etc.

In some examples, the requirements for multiple advertising channels overlap. The channel generator 106 can determine the anticipated demand for various types of overlapping content (e.g., based on time of year, holidays, etc.). If the demand is great enough, the channel generator 106 can pre-define advertising channels, requirements, etc. for the overlapping content. For example, in late summer advertisers often want to advertise against back-to-school content, or advertisers may want to advertise against Father's day content. The channel generator 106 can generate pre-configured advertising channels (e.g., by aggregating historical advertiser requirements, predicted advertiser requirements, etc.). For example, the channel generator 106 can predetermine a “back-to-school” advertising channel such that if Brand X desires to advertise against back-to-school content, then Brand X can simply use the predetermined back-to-school advertising channel (e.g., rather than needing to define a completely new set of advertising requirements). In some embodiments, the channel generator 106 pre-configures advertising requirements, such that the company can us the pre-defined requirements and/or incorporate them into a larger set of requirements (e.g., Brand X can incorporate back-to-school requirements into a larger set of requirements).

Referring to step 304, the channel generator 106 determines an initial set of training video content to use to generate the advertising channel. For example, the training video content should include videos that satisfy the advertising channel, as well as videos that do not satisfy the advertising channel. In some embodiments, a separate system (not shown) retrieves the set of training video content and delivers (or transmits) it to the channel generator 106. The training set of video content, combined with the baseline categorizations, can serve as the “ground-truth” dataset for channel generation. For example, the channel generator 106 can train various classification methods based on the training set of video content and the baseline categorizations, which define whether the method should classify each video as part of the advertising channel (or not).

In order to identify a set of videos that are likely to be assigned to the channel, the channel generator 106 can search for the files using existing classification technologies. For example, the channel generator 106 can search for videos using keyword searches, searching for videos based on user behavior, searching for videos based on user behavior publisher tags, etc. Referring to FIG. 1A, for example, the channel generator 106 retrieves media files (or videos) from the web servers 102 via the network 104 using a search engine. The channel generator 106 need not select only videos that are guaranteed to match the channel requirements, but can retrieve a large percentage of putative matches since the initial set of training video content can be vetted (e.g., using computerized methods and/or by panel review).

In some embodiments, the channel generator 106 can store data about the media files. For example, the channel generator 106 can collect and index data indicative of a user's experience while watching a media file on the internet (e.g., while watching the media file on a specific web page or on a collection of different web pages). For example, the channel generator 106 can store data indicative of where a particular media file is published, as well as any associated data for each of the publications. As an illustrative example, the channel generator 106 may determine that a particular clip from “Show X” is published on 100 different individual web pages across 15 different web domains. In this case, the channel generator 106 can retrieve a copy of the video itself, as well as: (a) any content that is published in and around the video when it is watched by the user, (b) any historical or estimated statistics that may exist in the system or third party systems relating to demographics or traffic levels, (c) links to and from the published URL, (d) screenshots of the appearance of the published webpage while playing the media file (and/or other media files), (e) data collected from partial or full renderings, (f) data collected by parsing associated HTML files (and/or other code files, such as XML files), (g) other stored metadata about the media file, (h) other relevant information that may be useful when defining the channel requirements (e.g., other information that may be helpful and/or necessary to properly pose the channel definition questions to a panel and receive reliable responses or answers), and/or the like.

In some embodiments, the channel generator 106 receives a list of the videos for the training set of video content (e.g., from the input device 110). The channel generator 106 can download/ingest the files on the list (e.g., from web servers 102) and extract and index all of the pertinent information (e.g., if it has not done so already). For example, the channel generator 106 can extract and index frames from the video, patches of pixels that move consistently throughout the video, audio samples from the video, text on the web pages where the video is published, and/or various viewer statistics (e.g., cookie based, behavior based, browser or technographic-based, or other forms of user demographic or behavioral data).

In some embodiments, the channel generator 106 predicts whether each video satisfies the set of requirements from step 302. Referring to FIG. 2, for example, the channel generator 106 can “answer” each question 204 in the requirements 200 using any existing classification model(s) that were already trained to get a best-estimate of whether the video satisfies the requirements 200. For example, the channel generator 106 can use the existing classification model(s) to predict what panel-generated answers may be to the questions 204.

In some embodiments, the channel generator 106 generates a web page for each video in the training set of video content. The web page can include, for example, a set of still images from the video, an executable copy of the video, and the set of requirements for the advertising channel. For example, the channel generator 106 can generate a video collage and store it in database 108. The video collage can be composed of individual frames of a video (e.g., that is laid out in a 2D grid) so that a human reviewer can quickly surmise the entire contents of a video at a glance, rather than having to watch the entire video. The associated web page can display the generated collage, as well provide the video in a player on the page (e.g., should a viewer desire a more in-depth review than just the collage). In some embodiments, the set of requirements can be displayed on the web page such that a user can view the collage, investigate the video in more depth if desired, and submit the results of their assessment as to whether each requirement in the set of requirements is satisfied for the associated video.

The channel generator 106 can use the set of requirements (step 302) and the training set of video content (step 304) to generate the classification model for the advertising channel (e.g., which is a trained best-method model for classifying media files into the defined channel). Referring to step 306, the channel generator 106 receives the baseline categorizations for the set of requirements for each video in the training set of video content. For example, a panel analyzes the training set of video content to determine whether each video satisfies the set of requirements (e.g., by analyzing the video content itself and/or related information, such as a video collage). Any number of panelists can submit their results to the channel generator 106. Each video can be submitted a plurality of times, and once a pre-defined number of matching results are obtained for a particular video, the video can be removed from the list of videos still requiring panel judgments. The panelists can be agents of the channel generator 106 (e.g., employees, contractors, etc.), or can be provided by a crowd-based service that offer panelists for manual web-based tasks (e.g., such as Amazon Mechanical Turk).

Once the channel generator 106 receives categorization information for each video (or the pre-defined number of judgments), the channel generator 106 can consolidate and store all the categorizations (e.g., in database 108). For example, the channel generator 106 can store a set of records containing, for each video in the training set of video content, information for the video and its associated baseline categorizations. For example, the channel generator 106 can store the video filename (e.g., and the URL for the video), a requirement, an initial automatic classification for the requirement (if any), and the associated baseline categorization for the requirement (e.g., the panel categorization(s)). There can be a record for each requirement, or a record for the set of requirements.

Referring to step 308, the channel generator 106 calculates a set of experiments to define video content for the advertising channel. The set of experiments can make up the best possible method for automatically determining whether a video should be included in an advertising channel (e.g., using machine learning techniques applied to all available information we have about the media files). In some examples, the channel generator 106 calculates a master set of experiments, and generates a classification model (e.g., the optimal set of experiments for the advertising channel) based on the master set of experiments. The master set of experiments and the classification model are described below.

FIG. 5 is an exemplary diagram 500 illustrating the calculation of a classification model 502 for defining an advertising channel. Each training method from the set of training methods 504 can be executed using various combinations of input parameters 506 (e.g., the data parameters from the training set of video content that are input into the experiment) and training parameters 508 (e.g., various parameters that control the functionality of the training method itself). The channel generator 106 can calculate the master set of experiments 510 by generating configurations for each training method using different sets of input parameters 506 and training parameters 508. The channel generator 106 can execute different training methods 504 (e.g., classification algorithms/methods), and can use the data in various combinations and feed it into different types of training algorithms (e.g., to gauge increases in efficiency, accuracy, etc.). The channel generator 106 executes the master set of experiments 510 (or a subset thereof) using the training set of video content 514 (e.g., including the preprocessed data) and the set of requirements 516 along with ground truth data 518 (indicative of whether a video from the training set of video content 514 satisfies the set of requirements 516) to achieve the set of classifiers 512. The channel generator 106 then generates the classification model 502 based on the set of classifiers 512.

Regarding the master set of experiments 510, the channel generator 106 can calculate the master set of experiments 510 based on the set of training methods 504. The master set of experiments 510 can be, for example, a master library of all training methods (or classification methods) available to the channel generator 106 (e.g., and stored in database 108) and different configurations for each training method. Therefore, in some embodiments each experiment 510 includes input parameters 506 (e.g., the data parameters, which can include the training set of video content itself), a training method 504, the set of requirements for the advertising channel (e.g., a list of questions stored in an appropriate data structure), and the ground-truth data for the set of requirements (e.g., the automatically generated answers to the questions for the input data set, and/or the panel acceptable answers to the questions) in order to assign a positive or negative membership for a particular media file for the channel the channel generator 106 is training The output of an experiment, the set of classifiers 512, can include, for example, intermediate log files for the experimented training method (e.g., which describe the results of various processing steps of the training method), a trained model parameter file (e.g., which can be reused with the training method to classify novel media files), a set of reports showing the results of the training against the test dataset, a decision function that maps the output of the model to a positive or negative assignment to the desired channel (e.g., based on the set of requirements, such as acceptable results to questions), and/or an estimate of the cost (e.g., based on time, computational intensity, etc.) of obtaining a classification of a novel media file using the trained model.

The channel generator 106 can preprocess information available about the media files. The information for the media file can come from a variety of sources, and can take a variety of forms. FIG. 6 is an exemplary table 600 showing various information sources 602, and the associated information types 604 for each information source 602. For example, as shown in row one 606 of table 600, the channel generator 106 can generate a color histogram from an image (or images) in the media file. As another example, as shown in row nine 608 of table 600, the channel generator 106 can calculate a word frequency in an audio track of a media file.

The channel generator 106 can preprocess the various information sources using feature extraction algorithms (e.g., stored in database 108). For example, the channel generator 106 can generate index data for each video in the training set of video content. The channel generator 106 can use the preprocessed data to generate the master set of experiments using different information sources and features as input to the experiments (e.g., information derived from a raw source data, information about the file generated via a fixed transformation of the data, etc.). For example, the channel generator 106 can determine the location and appearance of all human faces in a video, where the raw information is the video stream itself, and the fixed transformation maps the raw video bits to a set of rectangular coordinates corresponding to the location of the face on the video, a timestamp, an identity of the person, a confidence score, and/or the like. As another example, the channel generator 106 can extract a list of keywords from the web page the video was published on, which may contain the title and a description of the video. As another example, the channel generator 106 can extract closed caption information from the video file, or execute a speech-to-text analysis of the video to obtain a transcript of the spoken language in the video.

As an illustrative example, the set of training methods 504 can include an algorithm for detecting the identity of a person present in a digital video (or other distinguishing information for a person, such as race, sex, etc.), which may rely on the same attribute data as that relied upon by a general face detection algorithm in the set of training methods 504. If two or more training methods 504 rely on the same attribute data, the algorithms can be run in parallel (e.g., on the same machine or on different machines) such that the algorithms can reuse any common resources, such as various intermediate data objects or cached results (e.g., when generating the set of classifiers 512). The channel generator 106 can calculate a dependency graph of all intermediate computations and feature dependencies for the various algorithms in the library, which the channel generator 106 can use to schedule running the various algorithms to minimize cost and maximize the likelihood of obtaining a high-performing classifier for the advertising channel.

Referring further to the master set of experiments 510, the channel generator 106 can use the set of pre-processed features of the training set of video content, crossed with the set of possible training methods to generate a master list of all possible input parameters 506 (e.g., given the available data for the training set of video content) to all possible training methods 504 to yield a large list of all possible experiments 510 that the channel generator 106 can run to determine the best possible classification model 502 for defining the advertising channel (e.g., where the method satisfies the automatically generated data for the set of requirements, and/or the set of panel data).

The channel generator 106 can sort the master list of possible experiments 510 based on how likely each experiment is to yield useful classifications based on (a) previous results of the experiment(s), (b) measured or estimated marginal cost of training, (c) the cost of classifying new media files once training is completed, (d) method-specific features or performance attributes, (e) and/or other heuristically, empirically and/or analytically determined rules. Since each experiment 510 can include a set of inputs as well as an associated set of parameters, the total number of possible experiments 510 can be calculated as the number of methods, multiplied by the number of inputs, multiplied by the number of training parameter values. For example, if there are fifteen (15) training methods with fifty (50) sets of possible inputs, and twenty-five (25) configuration parameters for each method, with ten (10) values for each configuration parameter, the channel generator 106 could perform 15 methods×50 inputs×25 parameters×10 values for a total of 187,500 possible experiments. If various combinations of the 50 inputs are also factored in, choosing all sets of two possible inputs rather than one, there are 50 choose 2, or 1,225 combinations of inputs, which brings the number of possible experiments to 15 methods×1,225 inputs×25 parameters×10 values for a total of over 4.5 million experiments in the master set of experiments 510.

The channel generator 106 can sort (e.g., via priority sorting) the set of experiments 510 to, for example, select the best experiments to execute instead of running all of the experiments (e.g., to save time, resources, etc.). The channel generator 106 can select which experiments to execute based on past execution data of the candidate experiments (e.g., execution data stored for a different advertising channel). For example, the channel generator 106 can select the experiments based on past performance of the experiments against similar classification problems. The channel generator 106 can model tradeoffs of the various methods and combinations of data, such as cost/performance tradeoffs, to rank the methods based on such tradeoffs. For example, while some candidate experiments may be slightly more accurate than others, the speed and computational requirements may be so great that they are ranked lower than slightly less accurate candidates that have much less computational requirements. The channel generator 106 can use the sorted list of candidate experiments choose a subset of experiments to perform at once (e.g., simply by deciding on a number of experiments for the system to perform). For example, the channel generator 106 can be configured to select a predetermined number of the top sorted experiments (e.g., based on their priority). The channel generator 106 can combine two or more candidate experiments from the set of candidate experiments. For example, the channel generator can select candidate experiments with the greatest number of resources that can be shared, such as overlapping intermediate data structures and/or processing, to identify where processing and data transfer efficiencies could be achieved.

As an illustrative example, U.S. patent application Ser. No. 12/757,276, filed on Apr. 9, 2010 and entitled “Systems and Methods for Matching an Advertisement to a Video,” describes video preprocessing, which is hereby incorporated by reference herein in its entirety, addresses techniques for initiating and training detectors for detecting attributes or components of videos, and analyzing the trained detectors for performance. Such techniques can be used to estimate the total cost of performing any number of candidate experiments from the master set of experiments 510. The techniques can be executed in a cloud-based architecture that allows computational resources (such as processors, block storage devices, network devices and private network configurations) to be arbitrary scaled and leased for predetermined periods of time. For example, the remote distributed servers 112 of FIG. 1A can be utilized to analyze each candidate experiment. Advantageously, the channel generator 106 can take into account not only the success of the experiment, but also related considerations such as computational requirements to select a predetermined number of experiments to perform.

The success of each experiment can be evaluated based on whether the experiment selects videos that comply with the set of requirements (e.g., whether the experiment classifies a video in the same manner that a human panel would answer the channel requirement questions).

Since experiments can be executed with different sets of inputs, training methods, and training parameter values, the channel generator 106 can evaluate the individual success of each experiment by breaking up data for the training set of video content into different groups. For example, the channel generator can break the data into multiple non-overlapping subsets to generate a training set of data and a test set of data. As another example, the channel generator 106 can use multiple test sets and training sets to independently evaluate multiple subparts of training methods. Therefore, in some embodiments the input to each experiment in the master set of experiments 510 consists of the subsets of data (which serve as inputs to the training method), a training method 504, the set of requirements 516, and ground-truth data 518 for the requirements (e.g., indicative of whether the subsets of data should be given membership for a particular media file for the channel being trained).

Referring to the classification model 502, the channel generator 106 calculates the classification model 502 (e.g., an optimal set of experiments for achieving the advertising channel) based on the master set of experiments 510. Once the channel generator 106 executes the master set of experiments 510 (or a selected subset thereof), the result is the set of classifiers 512. The channel generator 106 can select one or more of the classifiers to achieve the classification model 502 for the channel. The channel generator 106 can run the classification model 502 on new video files to determine whether the video files should be included with video content for the advertising channel.

The channel generator 106 can calculate the classification model 502 by combining one or more classifiers from the set of classifiers 512. The channel generator 106 can mathematically analyze the set of classifiers 512 to determine which combination of classifiers to use for the classification model 502. The master set of classifiers 512 includes various classifiers, each trained on different inputs to predict whether video content should be included in the advertising channel. The classifiers can be combined using, for example, heuristics, analytics, and/or empirically defined rules. The combine classifiers can be used, logically or otherwise, in conjunction with each other on novel media files so as to achieve the best performance on estimating human panel selection of videos to determine inclusion of video content into the advertising channel. For example, the channel generator 106 can combine small subsets of trained classifiers using the Minimax approach, using the Iterative Dichotomiser 3 (ID3) algorithm, Stump classifiers and/or other boosting methods.

Experiments can be ranked by comparing their accuracy to the test set. For example, assume the system is training a basketball classifier. Ground-truth data can be received (e.g., generated by a panel) that indicates which videos from a training set of video content are basketball footage, as well as those videos that are not basketball footage. For this example, assume the received ground-truth data indicates that 800 videos include basketball content, while 200 do not include basketball content. The system splits the training set of video content into two separate portions for training and testing. One exemplary division may be a training set with 600 known basketball videos and 150 non-basketball videos, while the testing set includes the remaining 200 basketball videos and 50 non-basketball videos.

The system uses the training set to build classifiers of various kinds. For example, assume one classifier is based on a bag-of-words model (BoW model), and another classifier is based on color histograms. The system provides the training algorithms for these classifiers with the labeled training set as examples of videos that should and should not be classified as basketball videos. Each algorithm uses the labeled training set to build a model (classifier) that differentiates basketball content from non-basketball content. Next each model is executed with videos from the test set. The system compares (a) the results of the model's execution against the test set videos with (b) the classifications to the (presumed correct) classifications in the ground-truth data to determine the accuracy of each classifier.

Referring, for example, to the color histogram classifier, the basic idea of color histograms is to divide all of the possible color values into a predetermined number of buckets. For this example, assume the color histogram is configured to use ten buckets. The system assigns each pixel in an image to one of the ten buckets based on its color. The system histograms all of the pixels to arrive at the distribution of what portion of pixels are in each bucket. The system can represent an image as a ten-element vector, where each element is the percentage of pixels from the image that fall in the corresponding bucket.

In order to generate a histogram for a video, the system can choose many images (frames) of the video and histogram them together to get one histogram for the video. Continuing with this example, the example input parameters to our training algorithm are the color histograms of each of the videos from the training set, along with a classification for each training set video indicating whether or not it represents a basketball video (the ground-truth data).

Assume for this example that the system is configured to build a model that separates the basketball from the non-basketball histograms using Support Vector Machines (SVMs), which is a machine learning algorithm that takes two classes of vectors and learns how to differentiate between them. In the case of SVMs, there are several different kernels that can be used (e.g., Gaussian, radial basis, etc.). Further, for a given kernel there are several parameters that can be tuned, representing mathematical constants within the function used by the kernel. The system may calculate a different result depending on which kernel is selected, and the parameters used for that kernel (which is referred to as parameter selection).

Therefore, the range of training parameters would include which kernel to use, as well as which constants to use within that kernel for the SVM. The training parameters can also include the number of buckets to use for each histogram (e.g., 10). Another training parameter could be whether the system is to histogram each image in its entirety (e.g., in this case yielding a ten-element vector) or whether the system is to histogram each quadrant (upper-right, upper-left, etc.) of each image separately and then concatenate together the histograms for the quadrants, yielding a 40-element vector.

The accuracy of each classifier reflects the percentage of examples that it classified correctly. The system can rank the classifiers based on each classifier's associated accuracy. In some examples, the system considers the accuracy of the positive classifications and negative classifications separately (e.g., so that the system can use a different tolerance for false positive results compared to false negative results). For example, if the first classifier correctly classifies 95% of the clips that are actually basketball, then the first classifier has a 5% false negative rate, and if the first classifier correctly classifies 90% of the videos that are actually non-basketball, then it has a 10% false positive rate. If the second classifier correctly classifies 100% of the clips that are actually basketball, then it has a 0% false negative rate, and if the second classifier correctly classifies 80% of the videos that are actually non basketball, then it has a 20% false positive rate.

A (predetermined) utility function (e.g., decided in advance) can be used to calculate the “goodness” of a classifier as a function of its false positive rate and false negative rate. In this example, assume the function averages together (e.g., equally weighted) the accuracy on positives and the accuracy on negatives to determine the overall accuracy of the model. With such a utility function, then the first classifier (92.5% overall accuracy) is ranked as more effective than the second classifier (90% overall accuracy). Business considerations can be used to decide how much the system should err on the side of caution (or optimism) when making final assignments. For example, the system can incorporate an estimate of the computational cost of each classifier into the utility function so that if the system calculates two algorithms that perform equally well, the system selects the algorithm that consumes less computational resources.

The channel generator 106 can be configured to take into account various tradeoffs when determining the classification model 502 (e.g., for the individual classifiers and/or the classification model as a whole). For example, the channel generator 106 can factor in cost (e.g., in terms of resource utilization, equipment, etc.), an expected number of videos that will be assigned to the advertising channel (e.g., based on the number of videos available for assignment to the channel, whether the classification model should be configured to err on the side of exclusion or inclusion), how detrimental an improper categorization is for the advertising channel, and/or the like.

FIG. 4 is an exemplary diagram of a computerized method 400 for tracking the performance of a classification model to define a video advertising channel. Referring to FIG. 1A, at step 402 the channel generator 106 executes the classification model 502 using the training set of video content to calculate a baseline performance of the classification model at predicting whether the video satisfies the set of requirements (e.g., at predicting the results of the panel). At step 404, the channel generator 106 receives (or collects) a second training set of video content (e.g., as described above with respect to collecting the training set of video content). At step 406, the channel generator 106 executes the classification model using the second training set of video content to determine whether each video should be included with the advertising channel. At step 408, the channel generator 106 receives validation information for the identified one or more videos as to whether the channel generator 106 properly categorized each video as required by the set of requirements (e.g., by receiving panel review data for the second training set of video content).

If, for example, the channel generator 106 determines that the performance of the classification model is within a pre-determined threshold of accuracy (based on the validation information), the channel generator 106 can mark the classification model as complete and submit the classification model for inclusion in new systems. Otherwise, if the performance of the classification model does not meet the predefined threshold, the channel generator 106 can attempt to generate a better classification model by modifying one or more steps of the generation process (e.g., using a larger training set of video content), using different priority when selecting which experiments to run (e.g., from the master set of experiments), etc.

Once a classification model completes method 400 for validation/correction, the channel generator 106 can continue to monitor the classification model's performance. For example, it can be beneficial to track how a classification model's performance changes as the set of videos published on the internet changes, and as more data, methods, and features are added to the system. A similar method to method 400 of FIG. 4 can be used to periodically monitor performance of the classification models. For example, the channel generator 106 can randomly sample the results of the ongoing utilization of the classifier (e.g., based on a probability that adapts over time as the changes in the performance of the classifier become more stable and predictable). The media files classified during the random sampling interval can be used to review the performance of the classification model (e.g., by auditing the media files using panel review).

Given a set of classification models (or classifiers) that each assign media files positive or negative membership to different channels, one or more of the classifiers can be combined when generating future classification models. In some examples, the system can execute one classifier to provide partial information about the likelihood of answers to other classifiers. The system can cache partial results for use by future experiments, so as to make those future experiments less expensive since the experiments need not begin from scratch but can instead take advantage of the pre-computed data. For example, the system can be configured such that as the system ingests and assigns media files to channels, the system also caches partial results. Advantageously, such a process can allow for a constant flow of new information and results so that the next iteration of any classifier can be updated to reflect changes made to accommodate new data (e.g., newly learned attributes, differentiators, etc.).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 7985G available from Cisco System, Inc, and/or a Cisco® Unified Wireless Phone 7920 available from Cisco System, Inc.

One skilled in the art will realize the invention may be embodied in other specific forms without departing from the spirit or essential characteristics thereof. The foregoing embodiments are therefore to be considered in all respects illustrative rather than limiting of the invention described herein. The scope of the invention is thus indicated by the appended claims, rather than by the foregoing description, and all changes that come within the meaning and range of equivalency of the claims are therefore intended to be embraced therein.

1. A computerized method for defining an advertising channel, comprising:
receiving, by a computing device, a set of requirements for an advertising channel;
identifying, by the computing device, a training set of video content based on the set of requirements;
receiving, by the computing device, a set of baseline categorizations comprising, for each video in the training set of video content, a categorization for each requirement from the set of requirements; and
calculating, by the computing device, a set of experiments based on the training set of video content and the set of baseline categorizations to determine video content for the advertising channel.

2. The method of claim 1, wherein calculating the set of experiments comprises calculating a master set of experiments based on a set of candidate experiments, the training set of video content, and the set of baseline categorizations.

3. The method of claim 2, wherein:
each candidate experiment from the set of candidate experiments comprises (a) a set of input parameters and (b) a set of training parameters; and
calculating the master set of experiments comprises executing each candidate experiment using:
one or more different sets of input parameters determined based on the training set of video content; and
one or more different sets of training parameters.

4. The method of claim 2, wherein calculating the master set of experiments comprises combining two or more candidate experiments from the set of candidate experiments.

5. The method of claim 2, wherein calculating the master set of experiments comprises executing one or more candidate experiments from the set of candidate experiments based on a past execution of the one or more candidate experiments for a second advertising channel.

6. The method of claim 2, wherein calculating the set of experiments comprises calculating a classification model based on the master set of experiments, wherein the classification model is used to determine video content for the advertising channel.

7. The method of claim 6, wherein calculating the classification model comprises combining one or more experiments from the master set of experiments based on a mathematical analysis of the master set of experiments.

8. The method of claim 7, wherein calculating the classification model comprises calculating the classification model based on one or more tradeoffs, including:
a resource utilization required to execute the classification model;
a threshold determined based on an expected number of videos that will be assigned to the advertising channel;
an impact of improper categorization for the advertising channel; or any combination thereof.

9. The method of claim 1, further comprising:
generating a set of index data for the training set of video content comprising index data for each video in the training set of video content; and
calculating the set of experiments based on the set of index data.

10. The method of claim 1, further comprising generating a web page for each video in the training set of video content, the web page comprising:
a plurality of still images from the video;
a copy of the video; and
the set of requirements for the advertising channel.

11. The method of claim 1, further comprising:
executing the set of experiments using the training set of video content to calculate a baseline performance of the set of experiments;
receiving a second training set of video content;
executing the set of experiments using the second training set of video content to identify one or more videos for inclusion with the advertising channel; and
receiving validation information for the identified one or more videos.

12. The method of claim 1, wherein identifying the training set of video content based on the set of requirements comprises, for each video from the training set of video content:
retrieving the video from the internet using a keyword search, a user behavior search, a publisher tag search, or any combination thereof; and
storing user experience data indicative of a user's experience of watching the video on the internet.

13. A system for defining an advertising channel, comprising:
a database; and
a server in communication with the database configured to:
receive a set of requirements for an advertising channel and store the set of requirements in the database;
identify a training set of video content based on the set of requirements and store the training set of video content in the database;
receive, for each video in the training set of video content, a set of baseline categorizations for each requirement from the set of requirements; and
calculate a set of experiments based on the training set of video content and the set of baseline categorizations to determine video content for the advertising channel.

14. The system of claim 13, wherein the server is further configured to store each requirement from the set of requirements in the database as a question and an acceptable answer to the question.

15. The system of claim 13, wherein the server is further configured to calculate a master set of experiments based on a set of candidate experiments, the training set of video content, and the set of baseline categorizations.

16. The system of claim 15, wherein:
each candidate experiment from the set of candidate experiments comprises (a) a set of input parameters and (b) a set of training parameters; and
the server is further configured to calculate the master set of experiments by executing each candidate experiment using:
one or more different sets of input parameters determined based on the training set of video content; and
one or more different sets of training parameters.

17. The system of claim 15, wherein the server is further configured to calculate a classification model based on the set of experiments, wherein the classification model is used to determine video content for the advertising channel.

18. The system of claim 17, wherein the server is further configured to calculate the classification model by combining one or more experiments from the master set of experiments based on a mathematical analysis of the master set of experiments.

19. The system of claim 17, wherein the server is further configured to calculate the classification model based on one or more tradeoffs, including:
a resource utilization required to execute the classification model;
a threshold determined based on an expected number of videos that will be assigned to the advertising channel;
an impact of improper categorization for the advertising channel; or any combination thereof.

20. A computer program product, tangibly embodied in a non-transitory computer readable medium, the computer program product including instructions being configured to cause a data processing apparatus to:
receive a set of requirements for an advertising channel;
identify a training set of video content based on the set of requirements;
receive a set of baseline categorizations comprising, for each video in the training set of video content, a categorization for each requirement from the set of requirements; and
calculate a set of experiments based on the training set of video content and the set of baseline categorizations to determine video content for the advertising channel.
